(19) United States
(12) Patent Application Publication
(10) Pub. No.: US 2024/0351578 A1
(43) Pub. Date: Oct. 24, 2024

(54) Multi-Sensor Advanced Driver Assistance System and Method for Generating a Conditional Stationary Object Alert

(71) Applicant: Bendix Commercial Vehicle Systems LLC, Avon, OH (US)

(72) Inventors: Justin R. Miller, Elyria, OH (US); Andrew J. Pilkington, Avon Lake, OH (US)

(73) Assignee: Bendix Commercial Vehicle Systems LLC, Avon, OH (US)

(21) Appl. No.: 18/137,073

(22) Filed: Apr. 20, 2023

(51) Int. Cl. B60W 30/09; B60W 30/095; B60W 50/14

(52) U.S. Cl. CPC B60W 30/09; B60W 30/0956; B60W 50/14; B60W 2420/403; B60W 2420/408; B60W 2420/54; B60W 2554/20

(57) ABSTRACT

A multi-sensor advanced driver assistance system and method are provided for generating a conditional stationary object alert. In one embodiment, a vehicle has a first sensor configured to detect a stationary object in a path of the vehicle and a second sensor configured to determine whether or not the detected stationary object is another vehicle. If a determination cannot be made about whether or not the detected stationary object is another vehicle, a stationary object alert is generated. Other embodiments are provided.

### BACKGROUND

Some vehicles have a multi-sensor (e.g., a radar and a camera) advanced driver assistance system. In operation, the radar is used to identify a stationary object forward of the vehicle, and the camera is used to determine whether or not the stationary object is another vehicle. If the system determines that the stationary object is another vehicle, the system can automatically apply the vehicle's brakes to attempt to avoid colliding with the stationary object.

### BRIEF DESCRIPTION OF THE DRAWINGS

FIG. 1 is a diagram of a multi-sensor advanced driver assistance system of an embodiment.

FIG. 2 is a flow chart that illustrates an operation of a multi-sensor advanced driver assistance system of an embodiment.

FIG. 3 is a flow chart of method of an embodiment for generating a conditional stationary object alert.

### SUMMARY

In one embodiment, a non-transitory computer-readable storage medium is provided that stores computer-readable instructions that, when executed by one or more processors in a vehicle, cause the one or more processors to: detect a stationary object in front of the vehicle using a first forward-facing sensor of the vehicle; determine whether a second forward-facing sensor of the vehicle is in an error state that prevents the second forward-facing sensor from determining whether or not the detected stationary object is another vehicle; and in response to determining that the second forward-facing sensor of the vehicle is in the error state, cause a stationary object alert to be generated.

In another embodiment, a method is provided that is performed in a vehicle comprising a first sensor configured to detect a stationary object in a path of the vehicle. The method comprises determining whether a problem exists that prevents a second sensor in the vehicle from determining whether or not the detected stationary object is another vehicle; and in response to determining that the problem exists that prevents the second sensor from determining whether or not the detected stationary object is another vehicle, generating a stationary object alert.

In another embodiment, a multi-sensor advanced driver assistance system for use in a vehicle is provided comprising: a first sensor, a second sensor; and means for generating a stationary object alert in response to the first sensor detecting a stationary object and the second sensor not being able to determine whether or not the stationary object is another vehicle.

Other embodiments are possible, and each of the embodiments can be used alone or together in combination.

### DETAILED DESCRIPTION

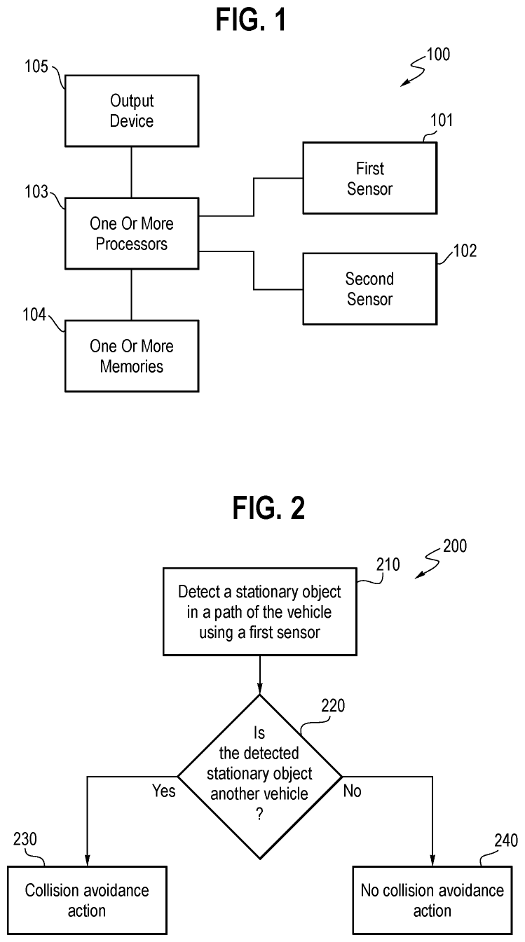

Turning now to the drawings, FIG. 1 is a diagram of a multi-sensor advanced driver assistance system (ADAS) 100 of an embodiment. This system 100 can be used in any suitable type of vehicle, such as, but not limited to, a tractor/truck configured to tow a trailer, a general-purpose automobile (e.g., a car, a sport utility vehicle (SUV), a cross-over, a van, etc.), a bus, a motorcycle, a scooter, a moped, an e-bike, etc.

As shown in FIG. 1, this system 100 comprises first and second sensors 101, 102 (additional sensors can be used), one or more processors 103, one or more memories 104, and an output device 105 (additional output devices can be used). Wired or wireless connections can be used to place the various components in FIG. 1 in communication with each other. In one embodiment, a Controller Area Network (CAN) is used.

In one embodiment, the first and second sensors 101, 102 are positioned to sense objects forward of the vehicle and, thus, are sometimes referred to herein as forward-facing sensors. It should be understood that “forward” is intended to denote a direction of travel and not necessarily a specific location on the vehicle. Also, “facing” is intended to refer a field of “view” of the sensor and not necessarily a specific position or orientation of the sensor. The first and second sensors 101, 102 can be of the same type or of different types. For example, the first sensor 101 can be configured to operate in a non-visible light spectrum, and the second sensor 102 can be configured to operate in a visible light spectrum. In one example implementation, the first sensor 101 uses radar, while the second sensor 102 is a camera. Of course, these are merely examples, and other types of sensors (e.g., lidar, ultrasound, etc.) can be used.

The one or more memories 104 can take any suitable form, such as, but not limited to, volatile or non-volatile memory, solid state memory, flash memory, random-access memory (RAM), read-only memory (ROM), programmable read-only memory (PROM), erasable programmable read-only memory (EPROM), electronic erasable programmable read-only memory (EEPROM), and variants and combinations thereof. In one embodiment, at least one of the one or more memories 104 is a non-transitory computer-readable storage medium capable of storing computer-readable instructions (e.g., readable program code, modules, routines, sub-routines, etc.) that can be executed by the one or more processors 103 to perform the functions described herein and, optionally, other functions. The one or more processors 103 can also take the form of a purely-hardware implementation (e.g., an application-specific integrated circuit (ASIC)) that performs function(s) without executing a computer program stored in the one or more memories 104.

Turning again to the drawings, FIG. 2 is a flow chart 200 illustrates an operation of the system 100. As shown in FIG. 2, first, the system 100 detects a stationary object in a path of the vehicle using the first sensor 101 (act 210). For example, the one or more processors 103 can (continuously or at some interval) analyze signals received from the first sensor 101 (e.g., radar) to determine if those signals indicate a stationary object in the path of the vehicle. As used herein, a “stationary object” refers to an object that is not moving. Examples of stationary objects include, but are not limited to, another vehicle, a pedestrian, a bridge, an overpass, a lane barrier, a cone, an energy-absorption barrel or other device, a telephone pole, a fire hydrant, traffic signs/lights, road debris, etc.

Next, the one or more processors 103 determine whether or not the detected stationary object is another vehicle (act 220). For example, the second sensor 102 can be a camera that captures images of the detected object, and the one or more processors 103 can perform image analysis of the captured images to look for features indicative of a vehicle (e.g., a license plate, a tail light, etc.).

If the one or more processors 103 determine that the detected stationary object is another vehicle, the one or more processors 103 can cause a collision avoidance action to be performed (act 230). A collision avoidance action can take any suitable form, such as, but not limited to, automatically applying a brake of the vehicle and/or automatically steering the vehicle to attempt to avoid collision with the stationary object. The one or more processors 103 can cause this directly (e.g., when the one or more processors 103 are also configured to execute collision avoidance functionality) or indirectly (e.g., by sending a control signal to separate processor(s) that are responsible for collision avoidance).

If the one or more processors 103 do not determine that the detected stationary object is another vehicle, no collision avoidance action is taken (act 240), and it is up to the driver to assess the stationary object and react accordingly (although, in other embodiments, an action can be taken).

As can be seen from the above, the second sensor 102 plays an important role, as it triggers the collision avoidance action when it provides a signal indicating that the stationary object is another vehicle. If there is a problem (sometimes referred to herein as an “error state”) that prevents the determination of whether or not the stationary object is another vehicle, the second sensor 102 may not be able to trigger the collision avoidance action, thereby leaving the driver without the benefit of the vehicle's safety system. For example, there can be a hardware and/or software problem in the second sensor 102 itself that prevents the second sensor 102 from taking a reading and/or communicating its reading to the one or more processors 103. As another example, there can be a problem with the communication channel between the second sensor 102 and the one or more processors 103, or there can be a lack of sensor redundancy/verification. As yet another example, there may not be a problem with the second sensor 102 itself, but there may be an obstruction that impairs the visibility of the second sensor 102 (e.g., snow, heavy rain, heavy fog, other poor visibility scenarios, a bug, debris on the windshield, an object that the driver places in the field of view of the second sensor 102 to interfere with its operation, such as a piece of tape or paper, etc.). In another example, there is no problem with the second sensor 102 or its communication channel, but the readings from the second sensor 102 are not sufficient to determine whether or not the stationary object is another vehicle. As yet another example, the problem can be detected when there is a failure to detect lane lines or other expected objects in the field of view.

In one embodiment, when a determination cannot be made whether or not a detected stationary object is another vehicle, the one or more processors 103 cause a stationary object alert to be generated using the output device 105. The stationary object alert and the output device 105 can take any suitable form. For example, the stationary object alert can take the form of an audible warning (e.g., an alarm or spoken word(s) outputted via a speaker in the cabin of the vehicle). Additionally or alternatively, the stationary object alert can take the form of a visual warning outputted via a display device in the cabin of the vehicle, via a heads-up display projected onto a windshield of the vehicle, on an indicator light on the hood, etc. Additionally or alternatively, the stationary object alert can take the form of vibrations (e.g. of the steering wheel, of the driver's seat, etc.). These are merely examples, and other forms of stationary object alerts can be used. Also, the one or more processors 103 can directly or indirectly cause a stationary object alert to be generated.

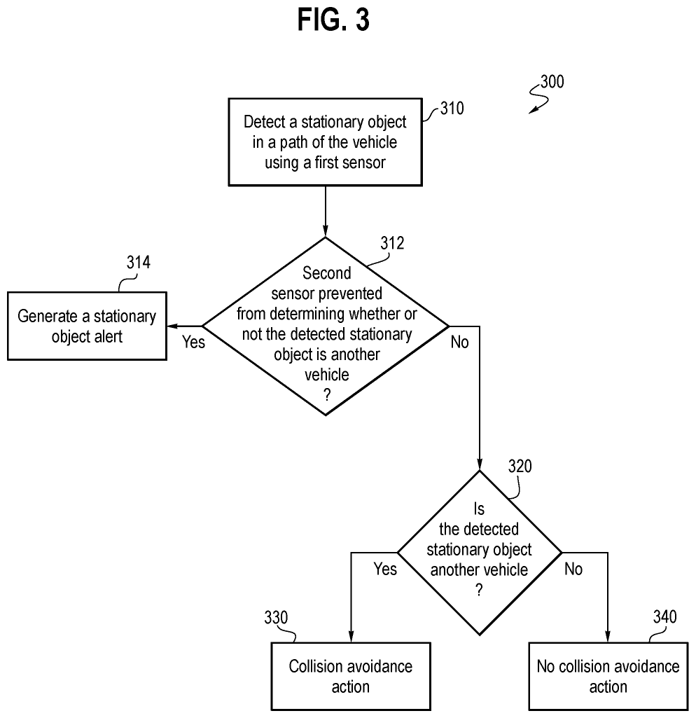

FIG. 3 is a flow chart 300 showing the acts of this method. Acts 310, 320, 330, and 340 are similar to acts 210, 220, 230, and 240 in the flow chart 200 in FIG. 2. New here is the inquiry of whether the second sensor 102 is prevented from determining whether or not the detected stationary object is another vehicle (act 312) and the generating of a stationary object alert in response to determining that the second sensor 102 is prevented from making such a determination (act 314). In one embodiment, the stationary object alert is generated only in response to determining that the second sensor 102 is prevented from making such a determination with respect to a detected stationary object. In other embodiments, the stationary object alert can be generated under other conditions.

This method can repeat with different outcomes over time. For example, there may be heavy fog conditions that cause the second sensor 102 (e.g., a camera) to report reduced performance due to poor visibility; however, the first sensor 101 (e.g., radar) may be operational and capable of identifying large, metallic, stationary objects in the path of travel. In this situation, the stationary object alert system would be enabled. However, after the fog clears and the second sensor 102 regains visibility to the environment, the stationary object alert system can revert to a disable condition.

There are several advantages associated with these embodiments. For example, these embodiments provide a safety feature (generating a stationary object alert) in situations where a collision avoidance action is not taken due to an error state. However, in such a situation, it is possible that the stationary object is not a collision hazard, such as when the stationary object an overpass that the driver would safely drive under. Despite the possibility (or even probability) of false alerts that may annoy a driver, these embodiments may still be desired, as they provide a “better than nothing” strategy and may help the driver maintain awareness.

As another example, these embodiments provide an advantage over a system that only uses a stationary object alert system. Some vehicles have only a single sensor (e.g., radar) to detect a stationary object or have a multi-sensor system with a mode of only detecting stationary objects. In such vehicles, a stationary object alert is generated every time a stationary object is detected. However, as noted above, a stationary object alert may be a false alert. In fact, a 2016 National Highway Traffic Safety

Administration (NHTSA) Field Study of Heavy-Vehicle Crash Avoidance Systems (DOT HS 812 280) found that over 90% of stationary object alerts were false alerts, suggesting that stationary object alerts are more of a nuisance than something useful.

By generating stationary object alerts only under specific circumstances (e.g., a sensor failure, fog or other poor visibility scenarios, lack of sensor redundancy! verification, etc.), these embodiments can reduce the number of stationary object alerts generated and, hence, the number of false alerts. That is, these embodiments can limit false warnings to only occur in narrowly-scoped operating environment. Also, drivers who are frustrated with false alerts have been known to tamper with the safety system to stop the generation of stationary object alerts. By reducing the number of false alerts, these embodiments provide the additional advantage of reducing the motivation for a driver to tamper with the system.

Additionally, some drivers have also been known to intentionally blind/block the camera's field of view to reduce system performance. However, doing so with these embodiments can result in the generation of stationary object alerts, which may be annoying to some drivers (even if the alert is not a false alert). So, a driver who otherwise would have blinded/blocked a camera may be discouraged to do so by these embodiments. Thus, these embodiments may have the additional benefit of deterring such tampering.

It should be understood that all of the embodiments provided in this Detailed Description are merely examples and other implementations can be used. Accordingly, none of the components, architectures, or other details presented herein should be read into the claims unless expressly recited therein. Further, it should be understood that components shown or described as being “coupled with” (or “in communication with”) one another can be directly coupled with (or in communication with) one another or indirectly coupled with (in communication with) one another through one or more components, which may or may not be shown or described herein. Additionally, “in response to” can be directly in response to or indirectly in response to. Also, the term “or” as used herein is to be interpreted as inclusive or meaning any one or any combination. Therefore, “A, B or C” means “any of the following: A; B; C; A and B; A and C; B and C; A, B and C”.

It is intended that the foregoing detailed description be understood as an illustration of selected forms that the invention can take and not as a definition of the invention. It is only the following claims, including all equivalents, which are intended to define the scope of the claimed invention. Accordingly, none of the components, architectures, or other details presented herein should be read into the claims unless expressly recited therein. Finally, it should be noted that any aspect of any of the embodiments described herein can be used alone or in combination with one another.

What is claimed is:

1. A non-transitory computer-readable storage medium storing computer-readable instructions that, when executed by one or more processors in a vehicle, cause the one or more processors to:
detect a stationary object in front of the vehicle using a first forward-facing sensor of the vehicle;
determine whether a second forward-facing sensor of the vehicle is in an error state that prevents the second forward-facing sensor from determining whether or not the detected stationary object is another vehicle; and
in response to determining that the second forward-facing sensor of the vehicle is in the error state, cause a stationary object alert to be generated.

2. The non-transitory computer-readable storage medium of claim 1, wherein the stationary object alert is generated only in response to the second forward-facing sensor of the vehicle being in the error state.

3. The non-transitory computer-readable storage medium of claim 1, wherein the first forward-facing sensor and the second forward-facing sensor are different types of sensors.

4. The non-transitory computer-readable storage medium of claim 3, wherein the first forward-facing sensor is configured to operate in a non-visible light spectrum and the second forward-facing sensor is configured to operate in a visible light spectrum.

5. The non-transitory computer-readable storage medium of claim 1, wherein the first forward-facing sensor is configured to operate using radar.

6. The non-transitory computer-readable storage medium of claim 1, wherein the first forward-facing sensor is configured to operate using lidar.

7. The non-transitory computer-readable storage medium of claim 1, wherein the first forward-facing sensor is configured to operate using ultrasound.

8. The non-transitory computer-readable storage medium of claim 1, wherein the second forward-facing sensor comprises a camera.

9. The non-transitory computer-readable storage medium of claim 1, wherein the error state is caused by a hardware or software problem in the second forward-facing sensor.

10. The non-transitory computer-readable storage medium of claim 1, wherein the error state is caused by impaired visibility of the second forward-facing sensor.

11. A method comprising:
performing in a vehicle comprising a first sensor configured to detect a stationary object in a path of the vehicle:
determining whether a problem exists that prevents a second sensor in the vehicle from determining whether or not the detected stationary object is another vehicle; and
in response to determining that the problem exists that prevents the second sensor from determining whether or not the detected stationary object is another vehicle, generating a stationary object alert.

12. The method of claim 11, wherein the stationary object alert is generated only in response determining that the problem exists that prevents the second sensor from determining whether or not the detected stationary object is another vehicle.

13. The method of claim 11, further comprising:
in response to determining that the problem does not exist:
determining that the detected stationary object is another vehicle; and
performing a collision avoidance action.

14. The method of claim 13, wherein the collision avoidance action comprises automatically braking the vehicle and/or automatically steering the vehicle to attempt to avoid the vehicle colliding with the detected stationary object.

15. The method of claim 11, wherein the first sensor is configured to use radar, lidar, or ultrasound.

16. The method of claim 11, wherein the second sensor comprises a camera.

17. A multi-sensor advanced driver assistance system for use in a vehicle, the system comprising:
a first sensor;
a second sensor; and
means for generating a stationary object alert in response to the first sensor detecting a stationary object and the second sensor not being able to determine whether or not the stationary object is another vehicle.

18. The system of claim 17, wherein the stationary object alert is generated only in response to the first sensor detecting the stationary object and the second sensor not being able to determine whether or not the stationary object is another vehicle.

19. The system of claim 17, wherein the first sensor is configured to use radar, lidar, or ultrasound.

20. The system of claim 17, wherein the second sensor comprises a camera.
